(19) United States
(12) Patent Application Publication
(10) Pub. No.: US 2007/0216362 A1
(43) Pub. Date: Sep. 20, 2007

(54) Method of indicating consumption of utility services with multi-level pricing

(76) Inventor: Lewis M. Kwit, New York, NY (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/365,042

(22) Filed: Feb. 28, 2006

(51) Int. Cl. H02J 7/00

(52) U.S. Cl. 320/132

(57) ABSTRACT

A method of indicating consumption of utility services with multi-level pricing. In the method, a rating system is created that is determined by the pattern of electric usage for different time periods. The rating has an arbitrarily set point level for each time period, each of the levels corresponding inversely to the price. An overall rating is calculated by multiplying the kilowatt hours consumed during a low-priced time period by the highest rating to arrive at a point score for that time period, multiplying the kilowatt hours consumed during a high-priced time period by the lowest rating to arrive at another point score for that time period, and multiplying the kilowatt hours consumed during any intermediate-priced time period by an intermediate rating to arrive at still another point score for that time period. All of the points for the time periods are added together, and the total points are divided by total kilowatt-hours consumed to arrive at an average rating level to help consumers compare the relative costs of their usage month to month, season by season and year to year.

### BACKGROUND OF THE INVENTION

1. Field of the Invention

The present invention relates to the provision of utility services with multi-level pricing, such as electrical service with Real Time Pricing, and more particularly, to a method of indicating to utility customers their usage of the services by utilizing an index which corresponds inversely to the actual price per time period.

2. Description of the Prior Art

Conservation of energy is, of course, a desirable goal, and this is true regardless of the source of the energy. Disregarding social factors, the actual price of each unit of energy has been previously and generally considered the primary indicator of energy usage to consumers. That is, users of energy look primarily at the cost of consumption rather than the actual number of units of energy consumed.

For example, most consumers of electricity can probably recite the cost of this service, but few would be able to say how many kilowatt hours they use over any period of time. Also, typically an electrical utility statement or bill only indicates the total amount of power consumed, but this total price provides no information to the consumer about when that power was consumed with respect to peak time periods of usage. Even fewer consumers would know that the cost of producing and distributing the electricity actually varies during a typical day. As a result, most people have no information or incentive to lead them into a consumption pattern to lower costs other than just to reduce consumption overall.

In an effort to promote conservation of power and electrical supplies and to correspondingly protect the environment, the technique of Real Time Pricing (RTP) was developed. Real Time Pricing also assists consumers to reduce their electrical service costs by giving them a more detailed view of their actual consumption. With Real Time Pricing, the consumer is billed at a different rate for electricity consumed during different time periods in the day. These different price tiers show the consumer which times are best for consumption, and this drives consumption toward those times. If a consumer can shift consumption related to a particular task, such as running a washing machine, to a time period with a lower price tier, the cost of the consumption will be correspondingly lowered. All consumers desire lower bills, and Real Time Pricing gives them a tool to control their costs beyond merely using less. Essentially Real Time Pricing introduces the element of time into the conservation equation. This technique has proven successful, for both urban and suburban consumers.

To be truly successful, Real Time Pricing must be iterative. Continuous adjustments are necessary to insure the best rate structure and to enhance the rate responsiveness of the consumers. The primary overall indicator is still the total cost of the bill for consumption over time, such as a monthly utility bill. However, consumption patterns obviously vary through the year. Electricity consumption is significantly higher during summer months for most locations, and gas or fuel oil consumption is higher during the winter. Thus, an electric bill will normally be higher in summer than winter. While the cost per unit of electricity may change month to month, for most consumers the cost of electricity in any given hour of a month is the same. Thus the cost at 3:00 PM when supplies may be seriously strained is the same as it would be at 3:00 AM when supplies are typically abundant.

To solve this problem and to help consumers gauge how their consumption compares, and thus how much they are saving, month to month, and in comparison with other consumers similarly situated, the present invention provides an index or rating system which corresponds inversely to price. In this index, the higher the rating, the greater the savings, as distinguished from the total cost of the monthly bill in which the lower the cost, presumably the greater the savings. Under the method of the present invention, the index rating is highest during periods of time where usage is low priced and lowest during periods where usage is priced high. For a time period or periods when rates are in between high and low prices the index rating is at a correspondingly intermediate level.

The index rating for the billing cycle can be provided on the consumer's bill. In this way, the consumer is provided with an indication (the index rating) that shows them how their overall consumption pattern corresponded to the consumption during different rates at different periods of time for the particular billing cycle, and this rating index can be compared with other months as well. The index rating allows consumers to gauge their overall pattern of electric consumption between periods of high and low cost power. The higher the rating the more favorable the usage pattern as it would emphasize usage during lower cost periods over higher cost periods.

### SUMMARY OF THE INVENTION

The present invention is a method of indicating energy consumption for a length of time and comprises the steps of dividing the length of time into a plurality of time periods, each time period having a predetermined price per unit of energy, setting a number of rating points with each rating point corresponding to one of the time periods wherein the value of each rating point is inversely related to the price, and determining an overall rating by calculating an average of the combined rating points for the time periods. As used herein, “inversely related” does not mean mathematically inverse. Rather, it simply means a higher rating point corresponds to a lower price or amount of energy and vice versa.

In the method, the step of determining an overall rating may comprise multiplying the value of the rating point for each time period by the units of energy consumed for the corresponding time period and thereby determining a rating point times energy product for the corresponding time period, adding the rating point times energy products for each time period together and thereby determining a sum, and dividing the sum by the total units of energy for the length of time. In one embodiment, one of the time periods is a period of higher overall (system wide) energy consumption, and another of the time periods is a period of lower overall (system wide) energy consumption.

As an example, the value of the rating point for the period of higher priced energy consumption may be 2, and the value of the rating point for the period of lower priced energy consumption may be 10. The value of the rating point for a period of time of intermediate overall (system wide) energy consumption, if any, may be 7. That is, the method may have at least three time periods including one of highest energy cost, one of lowest energy cost and one of intermediate energy cost.

In one embodiment of the method of the invention, the length of time is appropriately one month corresponding to an electric utility billing period.

Stated in another way, the present invention is a method of indicating energy consumption to at least some customers of an energy utility that comprises steps of setting a billing interval for energy services provided to the customers, dividing each day of the billing interval into a plurality of time periods wherein the time periods correspond to different levels of energy consumption by all customers, assigning different prices per unit of energy provided during each of the time periods, assigning a rating point level for each of the time periods wherein the rating point level is inversely related to the assigned price for the corresponding time period, and calculating an average rating point level for the billing period and submitting it to the customers.

The step of calculating comprises multiplying the rating point level for each time period by the units of energy consumed for the corresponding time period, adding the products of the multiplied rating point level and units of energy for each time period together, and dividing the sum of the products by the total units of energy.

Numerous objects and advantages of the invention will become apparent as the following detailed description of the preferred embodiment is read in conjunction with the drawings illustrating such embodiment.

### BRIEF DESCRIPTION OF THE DRAWINGS

FIG. 1 is a graph indicating average weekday usage in kilowatt-hours and Day Ahead Market prices related to a multi-resident building for one month.

FIG. 2 shows the building electrical demand in kilowatts before and after implementation of Real Time Pricing.

FIG. 3 illustrates a twelve-month electricity rate comparison for different pricing structures (RTP, SC-8 and SC-1).

FIG. 4 is a chart showing a sample winter rate schedule for residents in the building.

### DETAILED DESCRIPTION OF THE PREFERRED EMBODIMENT

The present invention is a method of indicating to consumers of energy, such as electrical power, how their consumption thereof relates to differences in pricing resulting from variations in demand during multiple time periods of the day. In particular, the invention is directed to consumption of electrical power, but is not intended to be so limited, and is also applicable to the distribution and consumption of other energy sources, such as natural gas, etc. The method is further applicable to any other utility where pricing may vary with time of demand, such as water, telecommunications services, etc.

### Prior Art

To help understand the method of the invention, some history of deregulation of electrical services and the implementation of Real Time Pricing in that industry is necessary.

In order to reduce consumption of electrical power, many states and communities have moved to unbundle utility electric services, establish an hourly wholesale electric market and create wholesale and retail competition. For example, in 1996 the State of New York began to deregulate its electricity service industry to encourage electric competition that would help meet its growing needs. Over the next two years, the New York Public Service Commission (PSC) and the State's regulated electric utilities negotiated a series of agreements to unbundle services, separating the generated portion of electricity from distribution and transmission service and ushering retail competition into the State's electricity market. The problem was acute enough that by 1999 the local utilities, Consolidated Edison Company (Con Edison) in New York City and Westchester County, and the Long Island Power Authority in Nassau and Suffolk Counties, had exceeded their forecasts for electricity demand for 2003. The situation was especially precarious in New York City, where the economy was booming, despite limited electric transmission capacity to import additional power, and a lack of new power plant construction for more than the previous quarter century.

In 2000 the PSC broached the possibility of time-sensitive pricing built on the emerging deregulated market, as a way to address the power supply crisis. The PSC directed electric utilities “to develop and offer tariff options that apply hourly market prices to actual hourly customer loads to provide improved incentives for utility customers to respond to price signals.” It further ordered utilities to establish a series of demand response programs, specifying that “[a]t a minimum, [utility] programs shall include making available to customers voluntary real-time (hourly) pricing tariffs.”

As part of the unbundling process, utilities are often required to divest their interests in power generating plants. As such electric utilities purchase wholesale power through a process administered by State Independent System Operators (ISO's). This often includes an auction process where prices based on supply and demand are set for each hour of the day. These prices set one day before are posted on ISO websites. In New York State, for example, this wholesale electricity market is called the Day Ahead Market (DAM).

In 2001 the New York State Independent System Operator (NYISO), which manages the state's wholesale electricity market, stated: “To achieve the full benefits of electricity market deregulation, some customers need to be exposed to the true price (determined either in the Day Ahead Market or in real time) of electricity. One of the many lessons learned from the recent California experience is that, in the presence of a capacity shortfall, when retail rates and wholesale prices are disconnected in time and space, the results can be disastrous.” The NYISO urged development of advanced meters that empower consumers, creation of real-time retail electricity tariff schedules and broad educational efforts aimed at consumers.

Real Time Pricing is particularly desirable in major metropolitan areas where there are a large number of multifamily housing units. For example, Real Time Pricing (RTP) in New York City's vast multifamily housing market is aimed at apartment buildings that purchase buildingwide electricity through a master meter. Master-metered buildings pass electric charges to residents through rent or maintenance fees, often as a standard monthly charge. To assure individual responsibility for electric usage, New York energy policy encourages master-metered apartment buildings to install submeters to bill individual apartments for their precise consumption. Other residential consumers receive electricity directly from the utility, and as small customers, pay a higher price for their direct-metered service. Con Edison, the New York City electric utility, filed tariff amendments to permit Real Time Pricing and proposed an interval meter program aimed at large customers, including residential buildings that receive bulk rate electric service through a master meter.

In 2001 an apartment building in New York City embarked on a lengthy process to implement Real Time Pricing. Prior to that, this multifamily building was electrically submetered in the early 1980s with conventional mechanical metering technology.

There were several stages in the development of this program beginning with the implementation of advanced electronic meters that recorded data in time increments and could be read from a remote site. Interval submeters for individual apartments were installed, and in October 2003, the building became the first in the city to purchase electricity at real-time prices. The New York State Public Service Commission considers Real Time Pricing as the hourly prices for the generated portion of the electricity bill to be set by the Independent System Operator's Day Ahead Market. The remainder is the delivery portion of the electricity bill and a charge for peak usage that indicates components for both generation and delivery.

Initial internal building rate schedules for the individual apartments for summer (see Table 1) and winter (see Table 2) were created, each with low, medium and high-priced rate tiers. Also created was a “critical” rate that would correspond to electricity curtailment events called by the Independent System Operator.

TABLE 1
Summer Rates

| | UNIT | | |
|---|---|---|---|
| | PRICE | | SUMMER |
| PRICE TIER | (¢/kWh) | SUMMER WEEKDAYS | WEEKDAYS |
| LOW | 11.389 | 10 P.M.-10 A.M. | 10 P.M.-10 A.M. |
| MEDIUM | 17.955 | 10 A.M.-3 P.M., 9-10 P.M. | 10 A.M.-10 P.M. |
| HIGH | 36.48 | 3-9 P.M. | N/A |
| CRITICAL | 91.2 | as called | as called |

TABLE 2
Winter Rates

| | UNIT | | |
|---|---|---|---|
| | PRICE | | WINTER |
| PRICE TIER | (¢/kWh) | WINTER WEEKDAYS | WEEKENDS |
| LOW | 9.99 | 10 P.M.-10 A.M. | 10 P.M.-10 A.M. |
| MEDIUM | 15.75 | 10 A.M.-5 P.M., 9-10 P.M. | 10 A.M.-10 P.M. |
| HIGH | 32 | 5-9 P.M. | N/A |
| CRITICAL | 86 | as called | as called |

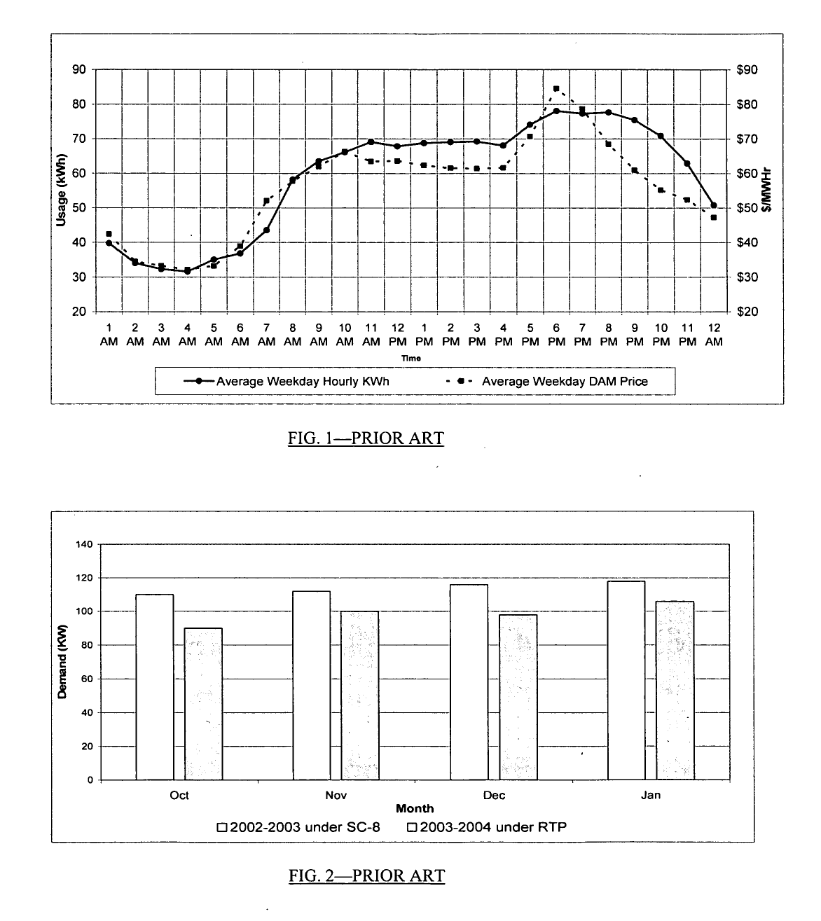

Apartment buildings typically peak later than the Day Ahead Market, which is driven by the load profile for the entire city. For example, in summer months, New York City peaks between 3:00 P.M. and 7:00 P.M. when commercial and transportation sectors peak and residents return home and switch on air conditioners. Residential use continues to climb, peaking from 7:00 P.M. to 9:00 P.M, often in accordance with “Prime Time” television viewing hours. FIG. 1 contrasts the load profile of the example building with price patterns of the NYISO Day Ahead Market on an average weekday in November 2002.

In the Real Time Pricing structure for this building, the highest prices were assigned to the 3:00 P.M. to 9:00 P.M. tier, which encompasses the highest prices in the Day Ahead Market and is the time period in which the building's demand typically peaks. The high rate tier was omitted on weekends because a great deal of commercial activity ceases with the work week, keeping Day Ahead Market prices low, and multifamily buildings rarely peak during weekends

Demand is a vital component in the price of power to multifamily buildings. It is not, however, a simple concept for consumers to understand. Utility electricity pricing is complicated. Demand charges are separate from the portion of electricity based upon the wholesale Day Ahead Market with its variable hourly prices. Demand charges are levied based upon the maximum half an hour of power used in a month. The underlying concept is that utilities must assure a sufficient generation and distribution infrastructure capable of supplying power whenever, and as much as, a customer requires. These demand charges represent between 25% and 50% of a building's monthly electric costs. Analysis of data indicated that the apartment building's peak demand most often occurs sometime between 7:00 P.M. and 9:00 P.M. and most often during weekdays. Thus in setting internal electric rates for apartment residents this factor needs to be considered. The graph in FIG. 2 was distributed in the building to explain and underscore the importance of peak demand reduction to the residents. It compares monthly peaks for October 2002 through January 2003 before RTP with the same months a year later, after the adoption of RTP and internal time-sensitive rates. The post-RTP decrease in demand was significant.

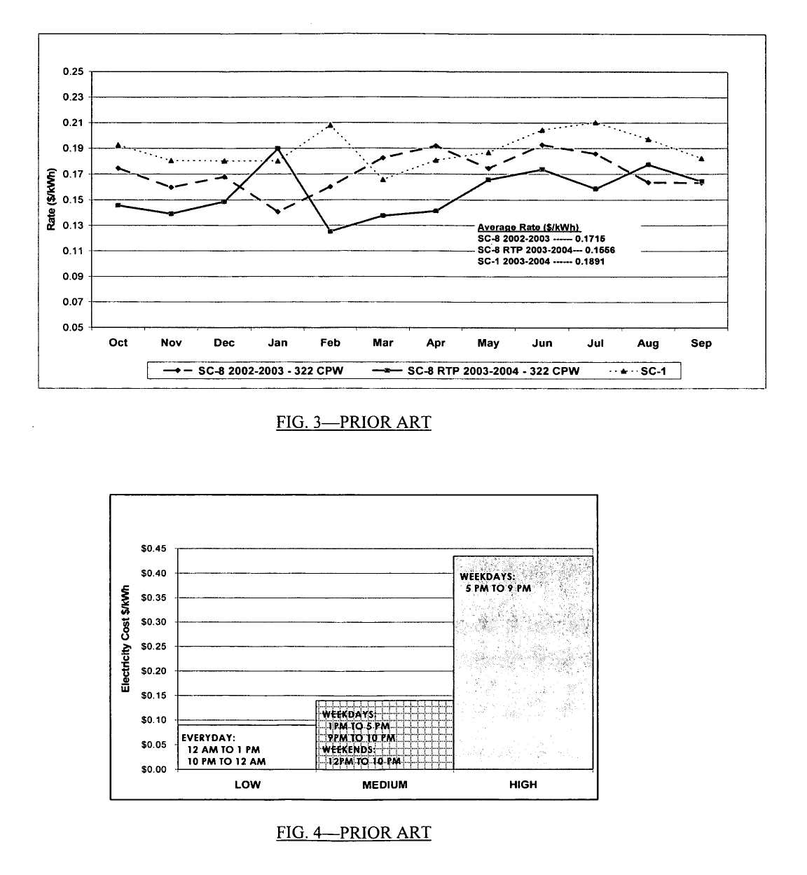

FIG. 3 depicts the actual buildingwide rates paid in the building's first year of Con Edison's RTP service. They are charted against rates for prior conventional SC-8 service and SC-1 rates for direct-metered apartments. Direct metered apartments are those where the utility provides each apartment with a bill based upon a reading of the utility's meter, just as in a single family home. The electric rate for the building's RTP service was lower than the other rates in all but January and August, when high heating and cooling demand forced DAM prices to rise.

The impact of RTP signals in the building is best assessed by comparing pre- and post-RTP consumption during the cooling season, when electricity in New York City is most scarce and expensive. July and August 2003 consumption before RTP implementation were compared with RTP consumption in July and August 2004.

Overall consumption decreased 5.22 percent from July 2003 to July 2004 after the new rates were in effect. Usage declined in all categories, but consumption in the high and medium-priced rate periods declined at more than three times the rate of the low period. See Table 3.

TABLE 3
Usage (kWh) in July 2003 and July 2004

| Month | Low | Med | High | Total |
|---|---|---|---|---|
| July 2003 | 31,903 | 17,021 | 10,702 | 59,627 |
| July 2004 | 31,098 | 15,536 | 9,880 | 56,513 |
| Difference | −806 | −1,486 | −822 | −3,113 |
| % Change | −2.52 | −8.73 | −7.68 | −5.22 |

As seen in Table 4 July 2004, consumption in moderate and high-priced periods made up smaller percentages of total consumption than in July of 2003.

TABLE 4
Percentage of Consumption by Price Tier

| Month | Low | Med | High |
|---|---|---|---|
| July 2003 | 53.50 | 28.55 | 17.95 |
| July 2004 | 55.03 | 27.49 | 17.48 |
| Difference | 0.015 | −0.011 | −0.005 |
| % Change | 2.85 | −3.70 | −2.60 |

Further, as shown in Table 5, the gap between pre- and post-RTP consumption widened in August. August 2004 consumption decreased by more than 13 percent and consumption in the high-priced hours decreased nearly a third more than in low- and medium-priced hours.

TABLE 5
Usage (kW) at 322 CPW in August 2003 and August 2004

| Month | Low | Med | High | Total |
|---|---|---|---|---|
| August 2003 | 29,609 | 14,301 | 10,484 | 54,394 |
| August 2004 | 25,902 | 12,500 | 8,800 | 47,202 |
| Difference | −3,707 | −1,801 | −1,683 | −7,192 |
| % Change | −12.52 | −12.59 | −16.06 | −13.22 |

As a consequence, consumption in the high-priced period in August 2004 shrank 3.2 percent to comprise a smaller percentage of total consumption than in August 2003. See Table 6. It is acknowledged that heightened energy awareness leading to the use of more efficient appliances and lighting may have been an additional contributing factor to the decrease.

TABLE 6
Percentage of Consumption by Price Tier

| Month | Low | Med | High |
|---|---|---|---|
| August 2003 | 54.43 | 26.29 | 19.27 |
| August 2004 | 54.87 | 26.48 | 18.64 |
| Difference | 0.004 | 0.002 | −0.006 |
| % Change | 0.81 | 0.73 | −3.27 |

These early results show that buildingwide consumption patterns changed in line with the internal rate tiers instituted through the building's RTP program. Subsequent analyses subtracted public space usage to determine the extent to which residents had changed discretionary usage patterns within individual apartments. They revealed a similar pattern of reduced usage in medium- and high-priced rate periods, indicating that individuals are gradually adapting consumption patterns to price signals.

In the process residents were provided more information about their consumption. Previous maintenance bills simply summarized electricity costs on a single line indicating kilowatt-hours used and total cost. Later, residents were shown what they were paying in each rate tier. This is illustrated by the example in Table 7. It was designed to reiterate price signals at a glance. Furthermore, rates were amended to increase the difference between rates in high priced time periods to those in low and moderate (medium) rate periods. This was done to strengthen price signals.

TABLE 7
Sample RTP Electric Bill

| Tier | Usage (kWh) | | Rate | Cost |
|---|---|---|---|---|
| Low | 363 | × | $0.09 | $32.67 |
| Medium | 156 | × | 0.14 | 21.84 |
| High | 68 | × | 0.44 | 29.58 |
| Total | 587 | | | $84.09 |

Later, this was expanded to note that the high period accounts for 12 percent of usage but a full 35 percent of costs. A graph such as shown in FIG. 4 was added to reiterate current rates. Subsequently, The gap between high rates and low and medium rates widened.

### The Present Invention

Even with all of this information, it is still difficult for consumers to compare their utility bills and consumption from month to month and particularly from one season of the year to another. As already noted, the total cost is not a good indicator of relative use. Because rates and consumption vary so much during a day, consumers have had no way to evaluate their usage patterns to determine if they are favorable in lowering overall costs or not.

The method of the present invention gives these consumers a tool to do this. It provides an indexing system to help consumers, such as residents in multifamily buildings, gauge how much they are saving from month to month and throughout the year. It can also be used to give a comparison with the building usage as a whole.

The method creates a rating system that is determined by the pattern of electric usage for different time periods. The rating system has an arbitrarily set rating point range, such as from 2 to 10. Because the points correspond inversely to price, the higher the rating, the greater the savings.

The rating is calculated through the following formula: The kilowatt hours consumed during the low-priced time period are multiplied by the value of the highest rating point, such as 10, to arrive at a point score for that time period; the kilowatt hours consumed during the high-priced time period are multiplied by the value of the lowest rating point, such as 2, to arrive at another point score for that time period; and the kilowatt hours consumed during an intermediate-priced time period, if any, are multiplied by the value of an intermediate rating point, such as 7, to arrive at still another point score for that time period. It will be seen by those skilled in the art that more than one intermediate time period may be used as required by the overall pricing structure involved. An additional time-period rating, such as 0, could be added for critical times, like those mentioned herein, as declared by the utility itself or regulatory agencies

All of the points for each time period are added together, and the total points are divided by total monthly kilowatt-hours consumed. Table 8 shows an example of the calculated index rating of the present invention for an individual consumer living in an apartment and using 851 KWH for a particular billing period. Table 9 shows the average apartment index rating for the entire building for the same billing period. In this example, the individual has a better index rating than the building average.

TABLE 8
Sample Apartment Rating

| Price Period | Points | | KWH Used | | |
|---|---|---|---|---|---|
| Low Usage | 10 | × | 540 | = | 5,400 |
| Medium Usage | 7 | × | 222 | = | 1,554 |
| High Usage | 2 | × | 89 | = | 178 |

7,132 ÷ 851 kWh = 8.38 Index Rating

TABLE 9
Building Average Rating

| | | | KWH | | |
|---|---|---|---|---|---|
| | | | Used | | |
| Price Period | Points | | (all apts.) | | |
| Low Usage | 10 | × | 16,850 | = | 168,850 |
| Medium Usage | 7 | × | 9,994 | = | 69,958 |
| High Usage | 2 | × | 3,358 | = | 7,076 |

245,884 ÷ 30,382 kWh = 8.09 Ave Index Rating

Based on the above-described formula used to calculate the rating of the present invention, it will be seen that a consumer having all consumption during the low usage time period would have a “perfect” score of 10, and a consumer using power only during the high usage time period would have the worst possible score of 2, ignoring any critical times. Of course, it would be virtually impossible for a consumer to be in either category alone, and the rating for each billing cycle would fall somewhere in between. This would hold true regardless of the time of year or regardless of usage by other consumers, such as residents in the same building.

By shifting individual usage as much as possible to the normally low usage time periods, the consumer will achieve a higher total rating under the present method. Not only will this result in cost savings, the consumer will see a rating score that can be used to easily compare how the consumer is doing month-to-month, season-to-season, and year-to-year. With this true comparative gauge, consumers can see the direct results of their attempts to shift energy consumption from one time period to another, and thus, have even more incentive to minimize usage during high usage time periods.

It will be seen, therefore, that the method of indicating consumption of utility services with multi-level pricing of the present invention is well adapted to carry out the ends and advantages mentioned as well as those inherent therein. While a presently preferred embodiment of the invention has been shown for the purposes of this disclosure, numerous variations and changes in the method may be made by those skilled in the art. All such changes are encompassed within the scope and spirit of the appended claims.

What is claimed is:

1. A method of indicating energy consumption for a length of time comprising: the steps of:
dividing the length of time into a plurality of time periods, each time period having a predetermined price per unit of energy;
setting a number of rating points corresponding to each of the time periods, wherein the value of each rating point is inversely related to the price; and
determining an overall rating by calculating an average of the combined rating points for all time periods.

2. The method of claim 1 wherein the step of determining an overall rating comprises:
multiplying the value of the rating point for each time period by the units of energy consumed for the corresponding time period and thereby determining a rating point times energy product for the corresponding time period;
adding the rating point times energy products for each time period together and thus determining a sum; and
dividing the sum by the total units of energy for the length of time.

3. The method of claim 1 wherein:
one of the time periods is a period of higher system wide energy consumption; and
another of the time periods is a period of lower system wide energy consumption.

4. The method of claim 3 wherein:
the value of the ratings point for the time period of higher energy consumption is 2; and
the value of the ratings point for the time period of lower energy consumption is 10.l

5. The method of claim 4 wherein the value of the ratings point for a time period of intermediate overall energy consumption is 7.

6. The method of claim 1 wherein there are at least three time periods including one of highest energy cost, one of lowest energy cost and one of intermediate energy cost.

7. The method of claim 6 wherein:
the value of the rating point for the time period of highest energy cost is two;
the value of the rating point for the time period of lowest energy cost is ten; and
the value of the rating point for the time period of intermediate energy consumption is between two and ten.

8. The method of claim 7 wherein the value of the rating point for the time period of intermediate energy cost is seven.

9. The method of claim 1 wherein the length of time corresponds to an electric utility billing period.

10. The method of claim 9 wherein the length of time is approximately one month.

11. A method of indicating energy consumption to at least some customers of an energy utility comprising steps of:
setting a billing interval for energy services provided to the customers;
dividing each day of the billing interval into a plurality of time periods wherein the time periods correspond to different overall levels of energy consumption by all customers;
assigning different prices per unit of energy provided during each of the time periods;
assigning a rating point level for each of the time periods wherein the rating point level is inversely related to the price for the corresponding time period; and
calculating an average rating point interval for the billing period and submitting it to the customers.

12. The method of claim 11 wherein the step of calculating comprises:
multiplying the rating point level for each time period by the units of energy consumed for the corresponding time period;
adding the products of the multiplied rating point level and units of energy for each time period together; and
dividing the sum of the products by the total units of energy for the time interval.

13. The method of claim 11 wherein:
one of the time periods is a period of higher overall energy consumption; and
another of the time periods is a period of lower overall energy consumption.

14. The method of claim 13 wherein:
the value of the rating point level for the time period of higher energy consumption is two; and
the value of the rating point level for the time period of lower energy consumption is ten.

15. The method of claim 14 wherein the value of the rating point level for a time period of intermediate overall energy consumption is 7.

16. The method of claim 11 wherein there are at least three time periods including one of highest energy consumption, one of lowest energy consumption and one of intermediate energy consumption.

17. The method of claim 15 wherein:
the value of the rating point level of highest energy consumption is two;
the value of the rating point level of lowest energy consumption is ten; and
the value of the rating point level of intermediate energy consumption is between two and ten.

18. The method of claim 17 wherein the value of the rating point level for the period of intermediate energy consumption is seven.

19. The method of claim 11 wherein the billing interval is approximately one month.
